(19) United States
(12) Patent Application Publication
(10) Pub. No.: US 2026/0243150 A1
(43) Pub. Date: Aug. 20, 2026

(54) CARBON DIOXIDE MINERALIZATION FOR SUBSURFACE STORAGE

(71) Applicant: King Fahd University of Petroleum and Minerals, Dhahran (SA)

(72) Inventors: Isah MOHAMMED, Dhahran (SA); Dhafer Abdullah AL SHEHRI, Dhahran (SA); Mohamed MAHMOUD, Dhahran (SA)

(73) Assignee: King Fahd University of Petroleum and Minerals, Dhahran (SA)

(21) Appl. No.: 19/057,156

(22) Filed: Feb. 19, 2025

(51) Int. Cl. E21B 41/00; C01F 11/18

(52) U.S. Cl. CPC E21B 41/0064; C01F 11/181; C01P 2002/60; C01P 2002/76; C01P 2004/32

(57) ABSTRACT

A method of carbon dioxide (CO₂) mineralization includes injecting a brine solution into a subterranean geological formation. The brine solution includes calcium chloride (CaCl₂)) in an amount of at least 2 wt. % and a chelating agent (EDTA) in an amount of at least 5 wt. % based on the total weight of the brine solution. The method further includes pressurizing the subterranean geological formation to a pressure of 20 psi to 2000 psi with CO₂ and reacting the CO₂ with the CaCl₂) in the subterranean geological formation at a temperature of 20 to 90° C. for 20 to 28 hours to form calcium carbonate (CaCO₃) in the subterranean geological formation. The calcium carbonate is in the form of crystals of aragonite, calcite, vaterite, and halite having spherical, prismatic, rhombohedral, and scalenohedral morphologies.

### STATEMENT REGARDING PRIOR DISCLOSURE BY THE INVENTORS

Aspects of the present disclosure are described in Mohammed, I. et al., “Production of colloidally stable calcium carbonate precipitates to enhance CO₂ subsurface storage through mineralization” published in Volume 243, Geoenergy Science and Engineering, which is incorporated herein by reference in its entirety.

### STATEMENT OF ACKNOWLEDGEMENT

Support provided by the College of Petroleum and Geoscience, King Fahd University of Petroleum and Minerals, Saudi Arabia is gratefully acknowledged.

### BACKGROUND

### Technical Field

The present disclosure is directed toward a method for carbon dioxide (CO₂) mineralization with calcium chloride (CaCl₂)), more particularly, a method for CO₂ mineralization in a subterranean geological formation with CaCl₂) to form calcium carbonate (CaCO₃) in the subterranean geological formation.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present disclosure.

Rising atmospheric carbon dioxide (CO₂) levels are leading to global climate change, causing warmer temperatures, severe storms, droughts, heavy rainfall, icecap melting, and rising sea levels. Human activities, like fossil fuel burning, industrial processes, and deforestation, are large contributors to CO₂ emissions. Global energy demands rely largely on fossil fuels. Renewable energy sources contribute to a small fraction of the global energy demand; therefore, there is interest in reducing carbon emissions and mitigating environmental impacts of fossil fuel usage for sustainable development and to curb global warming. Several CO₂ reduction methods and systems have been explored. One solution proposed to mitigate global warming is the capture of atmospheric CO₂ and permanent storage of the captured CO₂ in underground sedimentary reservoirs [Busch A. et al., Carbon dioxide storage potential of shales, International Journal of Greenhouse Gas Control, 2008, 2, 297-308]. The concept of geological CO₂ storage was first introduced in the 1970s, with the first successful storage taking place in the Sleipner gas field in the North Sea in 1996. Research and efforts are being made towards capturing and storing CO₂ to mitigate impacts on the atmosphere. A 2005 report from the Intergovernmental Panel on Climate Change (IPCC) stated that the potential of CO₂ storage capacity in geological formations is at least 2000 gigatons.

A drawback of CO₂ storage is the risk of leakage over time. Stored CO₂ may potentially escape from underground reservoirs through faults or cracks, negating proposed environmental benefits of underground CO₂ storage. Additionally, long-term monitoring is required to ensure the CO₂ remains securely trapped, which may be economically taxing and technically challenging. While bulk CO₂ storage in underground reservoirs raises safety issues, other storage techniques such as mineral trapping, which solidifies CO₂, and solubility trapping, which keeps CO₂ dissolved, are considered to be safer alternatives [Khosrokhavar, R. et al., Shale gas formations and their potential for carbon storage: opportunities and outlook, Environmental Processes, 2014, 1, 595-611].

Traditionally, CO₂ storage relies on three main techniques including solubility trapping, mineral trapping, and structural trapping. In solubility trapping, CO₂ dissolves into underground brine, which stores the CO₂ for long periods but risks leakage if the dissolved CO₂ escapes. Mineral trapping involves CO₂ reacting with cations in the rock to form stable carbonates, providing long-term security but occurring slowly, often over years or decades. When CO₂ is injected into the ground, the injected CO₂ may react with cations, like calcium (Ca), magnesium (Mg), and iron (Fe), found in rocks and brine. Those reactions lead to the formation of stable carbonate minerals, such as calcium carbonate (CaCO₃), which securely trap CO₂ in solid form. This method of storage is favorable since it reduces the risk of CO₂ leakage and enhances the long-term stability of stored carbon. While mineral entrapment is a potential solution for CO₂ storage, it occurs slowly and uses specific conditions to be effective. Structural trapping uses geological formations, such as impermeable rock layers, to physically trap CO₂ [Sun, Q. et al., Assessment of CO₂ trapping mechanisms in partially depleted oil-bearing sands, Fuel, 2020, 278, 118356]. Structural trapping is effective; however, it depends on the integrity of the geological structure, and if the geological structure is compromised, the CO₂ may leak. Each method has advantages and challenges, including slow rates of mineralization, potential leakage risks in solubility, and structural trapping. It is a concern that evaluating CO₂ storage locations may focus more on storage conditions rather than the specific storage mechanism [Li, Y. and Pang, Z. CO₂ trapping state in saline aquifers and its implications for site-scale storage capacity assessment, Procedia Earth and Planetary Science, 2017, 17, 488-91].

Accordingly, an object of the present disclosure to provide a method of CO₂ mineralization that may circumvent the drawbacks and limitations of the methods already known in the art, such as high cost, low longevity, poor control, and probability of leakage.

### SUMMARY

In an exemplary embodiment, a method of carbon dioxide (CO₂) mineralization is described. The method includes injecting a brine solution into a subterranean geological formation. The brine solution includes calcium chloride (CaCl₂)) in an amount of at least 2 percent by weight (wt. %) based on a total weight of the brine solution and a chelating agent in an amount of at least 5 wt. % based on a total weight of the brine solution. The method further includes pressurizing the subterranean geological formation to a pressure of 20 to 2000 pounds per square inch (psi) with CO₂ and reacting the CO₂ with the CaCl₂) in the subterranean geological formation at a temperature of 20 to 90 degrees Celsius (° C.) for 20 to 28 hours (h) to form calcium carbonate (CaCO₃) in the subterranean geological formation. The calcium carbonate is in the form of crystals of aragonite, calcite, vaterite, and halite having spherical, prismatic, rhombohedral, and scalenohedral morphologies.

In some embodiments, the brine solution includes one or more salts selected from a group including sodium chloride (NaCl), sodium bicarbonate (NaHCO₃), sodium sulfate (Na₂SO₄), magnesium chloride (MgCl₂), and CaCl₂).

In some embodiments, the chelating agent is an ethylenediaminetetraacetic acid (EDTA).

In some embodiments, the brine solution has a total dissolved solids (TDS) value of 55,000 to 60,000 parts per million (ppm).

In some embodiments, the brine solution has a TDS value of 210,000 to 215,000 ppm.

In some embodiments, 4 to 5 times an amount of carbonate precipitate is formed at a temperature of 80° C., compared to the amount of carbonate precipitate formed at a temperature of 50° C. at a pressure of 50 psi and the chelating agent in an amount of 20 wt. %.

In some embodiments, the brine solution includes CaCl₂) in an amount of 7.5 wt. %, and 55 to 60 times an amount of carbonate precipitate is formed at a chelating agent amount of 15 wt. % compared to the amount of carbonate precipitate formed at a chelating agent amount of 5 wt. % at a temperature of 80° C. at a pressure of 500 psi.

In some embodiments, the brine solution includes CaCl₂) in an amount of 10 wt. %, and 18 to 24 times an amount of carbonate precipitate is formed at a chelating agent amount of 15 wt. % compared to the amount of carbonate precipitate formed at a chelating agent amount of 5 wt. % at a temperature of 30° C. at a pressure of 12 to 15 psi.

In some embodiments, the brine solution includes CaCl₂) in an amount of 10 wt. %, and 5 to 10 times an amount of carbonate precipitate is formed at a chelating agent amount of 15 wt. % compared to the amount of carbonate precipitate formed at a chelating agent amount of 5 wt. % at a temperature of 50° C. at a pressure of 12 to 15 psi.

In some embodiments, the brine solution includes CaCl₂) in an amount of 10 wt. %, and 3 to 7 times an amount of carbonate precipitate is formed at a chelating agent amount of 15 wt. % compared to the amount of carbonate precipitate formed at a chelating agent amount of 5 wt. % at a temperature of 50° C. at a pressure of 500 psi.

In some embodiments, the brine solution includes CaCl₂) in an amount of 20 wt. % and the chelating agent in an amount of 10 wt. %, and 100 to 110 times an amount of carbonate precipitate is formed at a pressure of 1500 psi compared to the amount of carbonate precipitate formed at a pressure of 100 psi at a temperature of 50° C.

In some embodiments, reacting the CO₂ with the CaCl₂) forms one or more selected from a group including calcite, vaterite, aragonite, and dolomite.

In some embodiments, reacting the CO₂ with the CaCl₂) forms at least one calcite having a morphology selected from a group including spherical, prismatic, rhombohedral, scalenohedral, and amorphous.

In some embodiments, the morphology is rhombohedral having rectangular particles with a longest dimension of 25 to 150 micrometers (μm) and fractures in the rectangular particles having a length of 20 to 100 μm.

In some embodiments, the morphology is scalenohedral having particles with a longest dimension of 10 to 130 μm, where the particles include layered flakes having a longest dimension of 5 to 20 μm.

In some embodiments, the morphology is spherical having particles with a diameter of 2 to 15 μm.

In some embodiments, the morphology is prismatic having columnar particles with a longest dimension of 30 to 90 μm and a diameter of 5 to 12 μm.

In some embodiments, the brine solution includes CaCl₂) in an amount of 20 wt. % and the chelating agent in an amount of 10 wt. %, and the carbonate precipitate formed includes 3 to 5 wt. % aragonite, 80 to 85 wt. % calcite, 11 to 13 wt. % vaterite, and 0.5 to 1 wt. % halite at a pressure of 50 psi and a temperature of 80° C.

In some embodiments, the brine solution includes CaCl₂) in an amount of 20 wt. % and the chelating agent in an amount of 10 wt. %, and the carbonate precipitate formed includes 75 to 85 wt. % calcite and 15 to 25 wt. % vaterite at a pressure of 500 psi and a temperature of 80° C.

In some embodiments, the brine solution includes CaCl₂) in an amount of 20 wt. % and the chelating agent in an amount of 10 wt. %, and the carbonate precipitate formed includes 3 to 6 wt. % aragonite, 20 to 30 wt. % calcite, 1 to 5 wt. % vaterite, and 65 to 70 wt. % halite at a pressure of 1000 psi and a temperature of 80° C.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flow chart of a method for carbon dioxide (CO₂) mineralization, according to certain embodiments.

FIG. 2A depicts a scanning electron microscope (SEM) image of formation of rhombohedral calcite crystals replacing dissolved spherical calcium chloride (CaCl₂)) crystals, according to certain embodiments.

FIG. 2B depicts an energy-dispersive X-ray spectroscopy (EDX) elemental map of the rhombohedral calcite crystals, depicting a distribution of calcium (Ca), sodium (Na), carbon (C), chlorine (Cl), and oxygen (O), in the rhombohedral calcite crystals, according to certain embodiments.

FIG. 2C depicts an SEM image of replacement of partially dissolved sodium chloride (NaCl) by rhombohedral calcite with 20 percent by weight (wt. %) CaCl₂) and 20 wt. % ethylenediaminetetraacetic acid (EDTA) at 50 degrees Celsius (° C.) and 50 pounds per square inch (psi), according to certain embodiments.

FIG. 2D depicts an EDX elemental map of partially dissolved NaCl depicting the distributions of Ca, Na, C, Cl, and O, according to certain embodiments.

FIG. 2E depicts an SEM image of stacked rhombohedral calcite crystals with 20 wt. % CaCl₂) and 20 wt. % EDTA at 50° C. and 50 psi, according to certain embodiments.

FIG. 2F depicts an SEM image depicting fractures within the rhombohedral calcite, according to certain embodiments.

FIG. 3A depicts an SEM image of scalenohedral calcite with 20 wt. % CaCl₂) and 20 wt. % EDTA at 80° C. and 1500 psi, according to certain embodiments.

FIG. 3B is an EDX spectra of elemental mapping for scalenohedral calcite with 20 wt. % CaCl₂) and 20 wt. % EDTA at 80° C. and 1500 psi, according to certain embodiments.

FIG. 3C depicts an SEM image of scalenohedral calcite with 20 wt. % CaCl₂ and 20 wt. % EDTA at 80° C. and a pressure of 1500 psi, according to certain embodiments.

FIG. 3D is an EDX spectra for the scalenohedral calcite with 20 wt. % CaCl₂ and 20 wt. % EDTA at 80° C. and 1500 psi, according to certain embodiments.

FIG. 3E depicts an SEM image of prismatic calcite with 20 wt. % CaCl₂) and 20 wt. % EDTA at 80° C. and 1000 psi, according to certain embodiments.

FIG. 3F depicts an SEM image of prismatic calcite with 20 wt. % CaCl₂) and 20 wt. % EDTA at 80° C. and 1500 psi, according to certain embodiments.

FIG. 4A depicts an SEM image of spherical calcite with formation water (FW) and 20 wt. % EDTA at 50° C. and 50 psi, according to certain embodiments.

FIG. 4B depicts an EDX spectra of elemental distribution of Ca, Na, C, Cl, and O with FW and 20 wt. % EDTA at 50° C. and 50 psi, according to certain embodiments.

FIG. 4C depicts an EDX elemental map of Ca with FW and 20 wt. % EDTA at 50° C. and 50 psi, according to certain embodiments.

FIG. 4D depicts an EDX elemental map of Mg with FW and 20 wt. % EDTA at 50° C. and 50 psi, according to certain embodiments.

FIG. 4E is an SEM image depicting a replacement of partially dissolved NaCl by spherical calcite, according to certain embodiments.

FIG. 4F is a SEM image depicting an infilling of fibrous dissolution pores within NaCl by spherical calcite, according to certain embodiments.

FIG. 5A is an SEM image of amorphous calcite formed from incomplete replacement of partially to pervasively dissolved NaCl with FW and 20 wt. % EDTA at 50° C. and 50 psi, according to certain embodiments.

FIG. 5B is an EDX spectra of the amorphous calcite depicting the presence of Na and Ca in the amorphous calcite, according to certain embodiments.

FIG. 5C is an SEM image with a scale of 10 micrometers (μm) for the amorphous calcite, according to certain embodiments.

FIG. 5D is an EDX spectra for the amorphous calcite depicting the presence of both Na and Ca in the amorphous calcite, according to certain embodiments.

FIG. 6A is a table depicting an amount of precipitate for surface mineralization of CO₂ at 30° C., according to certain embodiments.

FIG. 6B is a table depicting equilibrium pH for mineralization for surface mineralization of CO₂ at 30° C., according to certain embodiments.

FIG. 7A is a table depicting an amount of precipitate for surface mineralization of CO₂ at 50° C., according to certain embodiments.

FIG. 7B is a table depicting equilibrium pH for mineralization for surface mineralization of CO₂ at 50° C., according to certain embodiments.

FIG. 8A is a table depicting an amount of precipitate for subsurface mineralization of CO₂ at 30° C., according to certain embodiments.

FIG. 8B is a table depicting equilibrium pH for mineralization for subsurface mineralization of CO₂ at 30° C., according to certain embodiments.

FIG. 9A is a table depicting an amount of precipitate for subsurface mineralization of CO₂ at 50° C., according to certain embodiments.

FIG. 9B is a table depicting equilibrium pH for mineralization for subsurface mineralization of CO₂ at 50° C., according to certain embodiments.

FIG. 10A is a table depicting an amount of precipitate for subsurface mineralization of CO₂ at 80° C., according to certain embodiments.

FIG. 10B is a table depicting equilibrium pH for mineralization for subsurface mineralization of CO₂ at 80° C., according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “compound” refers to a chemical entity, regardless of its phase (i.e., solid, liquid, or gas) and/or state (crude mixture, purified, or isolated).

As used herein, the term “particle” refers to an object that acts as a whole unit with regard to its properties.

As used herein, the terms “particle size” may be thought of as the length or longest dimension of a particle. The greatest distance that can be measured from one point on a shape through its center to a point directly across from it is referred to as the “diameter” for a circle, oval, ellipse, and multilobe. Unless otherwise noted, the term “diameter” for polygonal shapes refers to the maximum length that can be measured between a polygon's vertex at the center of the face and its opposite vertex. In the present disclosure “particle size” and “particle diameter” may be used interchangeably.

As used herein the term “deionized water” refers to the water that has ions removed.

As used herein, the term “room temperature” refers to a temperature range of 25° C. (° C.)±3° C.

As used herein, the term “subterranean geological formation” refers to a large-scale geological feature that exists beneath the Earth's surface.

As used herein, “mineralization” refers to a chemical reaction that removes carbon dioxide (CO₂) from the atmosphere and stores it as a solid mineral.

As used herein, “ion concentration” refers to an amount of ions in a solution or in the atmosphere.

As used herein, the term “brine solution” refers to an aqueous solution containing dissolved salts, where the concentration of dissolved salts may achieve various properties such as increased ionic strength, enhanced solubility of gases (such as CO₂), and/or facilitate specific chemical reactions.

As used herein, “total inorganic carbon (TIC)” refers to a concentration and/or amount of inorganic carbon species in a solution, including CO₂, bicarbonate (HCO₃⁻), and carbonate (CO₃²⁻), which may impact pH, alkalinity, and carbon cycling in aquatic environments.

As used herein, “total dissolved solids (TDS)” refers to a measure of the amount of solid material dissolved in water. TDS include dissolved minerals, salts, metals, and contaminants, and is often measured in parts per million (ppm).

As used herein, “formation water (FW)” refers to water that is naturally present in underground rock formations and/or oil reservoirs that contain dissolved minerals and salts. Formation water may be known as “produced water” when it is extracted during oil and gas production processes.

A weight percent of a component, unless specifically stated to the contrary, is based on the total weight of the formulation or composition in which the component is included. For example, if a particular element or component in a composition or article is said to have 5 percent by weight (wt. %), it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed toward a method for the rapid precipitation of calcite from a calcium chloride (CaCl₂))-rich solution through interaction with CO₂ in the presence of a chelating agent. The method results in the formation of calcite in less than one day (24 hours). The present disclosure also includes a method for analyzing the bulk and mineralogical composition of the precipitates, utilizing techniques such as scanning electron microscopy to identify crystal forms of calcite. Furthermore, the present disclosure enables the use of effluent from water treatment processes, such as reverse osmosis, as a feed material for the process, facilitating the conversion of wastewater into a valuable resource. This approach contributes to sustainable CO₂ sequestration and addresses wastewater management, offering a solution with environmental and economic benefits.

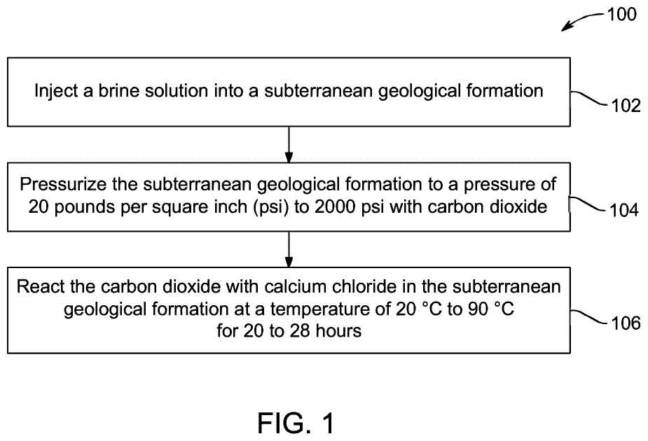

FIG. 1 illustrates a flow chart of a method 100 of CO₂ mineralization. CO₂ mineralization is a geochemical process in which CO₂ reacts with naturally occurring minerals, particularly metal silicates and/or oxides, to form solid carbonates. This process typically involves the interaction of CO₂ with divalent metal cations (such as calcium, magnesium, iron, and the like) to form stable carbonate minerals like calcite (CaCO₃), magnesite (MgCO₃), siderite (FeCO₃), and the like. The process may occur in natural geological settings, such as basaltic rock formations and/or mineral-rich groundwater and is also being explored in engineered environments as a method for permanent carbon sequestration. The resulting mineral carbonates can store CO₂ in a stable and long-term form, mitigating atmospheric CO₂ levels and contributing to climate change mitigation strategies. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes injecting a brine solution into a subterranean geological formation. The subterranean geological formation may include, but is not limited to, a depleted oil reservoir, a depleted gas reservoir, a sour reservoir, a hydrocarbon hydrocarbon-bearing subterranean formation, a saline formation, an un-minable coal bed, and/or a combination thereof.

Suitable examples of salts in the brine solution may include sodium chloride (NaCl), sodium bicarbonate (NaHCO₃), sodium sulfate (Na₂SO₄), magnesium chloride (MgCl₂), potassium chloride (KCl), potassium sulfate (K₂SO₄), potassium bicarbonate (KHCO₃), calcium sulfate (CaSO₄), calcium nitrate (Ca(NO₃)₂), magnesium sulfate (MgSO₄), magnesium nitrate (Mg(NO₃)₂), magnesium acetate (Mg(CH₃CO₂)₂), sodium carbonate (Na₂CO₃), disodium hydrogen phosphate (Na₂HPO₄), sodium nitrate (NaNO₃), potassium bicarbonate (KHCO₃), magnesium bicarbonate (Mg(HCO₃)₂), iron (II) chloride (FeCl₂), iron (III) chloride (FeCl₃), iron (II) sulfate (FeSO₄), potassium sulfate (K₂SO₄), barium sulfate (BaSO₄), lithium chloride (LiCl), lithium sulfate (Li₂SO₄), lithium nitrate (LiNO₃), CaCl₂), combinations thereof, and the like. In some embodiments, the brine solution includes one or more salts selected from a group including NaCl, NaHCO₃, NaSO₄, MgCl₂, and CaCl₂). In a preferred embodiment, the brine solution includes CaCl₂).

The brine solution includes CaCl₂) in an amount of at least 2 wt. %, preferably at least 3 wt. %, preferably at least 4 wt. %, preferably at least 5 wt. %, preferably at least 6 wt. %, preferably at least 7 wt. %, preferably at least 8 wt. %, preferably at least 9 wt. %, preferably at least 10 wt. %, preferably at least 11 wt. %, preferably at least 12 wt. %, preferably at least 13 wt. %, preferably at least 14 wt. %, preferably at least 15 wt. %, preferably at least 16 wt. %, preferably at least 17 wt. %, preferably at least 18 wt. %, preferably at least 19 wt. %, and preferably at least 20 wt. %, based on a total weight of the brine solution.

In some embodiments, the brine solution has a TDS value of 210,000-215,000 ppm, preferably 211,000-214,500 ppm, more preferably 212,000-214,000 ppm, and yet more preferably 213,000-213,800 ppm, based on a total weight of the brine solution. In a preferred embodiment, the brine solution has a TDS value of about 213,734 ppm, based on a total weight of the brine solution. In other embodiments, the brine solution has a TDS value of 55,000-60,000 ppm, preferably 56,000-59,000 ppm, more preferably 56,500-58,500 ppm, and yet more preferably 57,000-58,000 ppm, based on a total weight of the brine solution. In a preferred embodiment, the brine solution has a TDS value of about 57,670 ppm, based on a total weight of the brine solution.

The brine solution includes a chelating agent in an amount of at least 5 wt. %, preferably at least 6 wt. %, preferably at least 7 wt. %, preferably at least 8 wt. %, preferably at least 9 wt. %, preferably at least 10 wt. %, preferably at least 11 wt. %, preferably at least 12 wt. %, preferably at least 13 wt. %, preferably at least 14 wt. %, preferably at least 15 wt. %, preferably at least 16 wt. %, preferably at least 17 wt. %, preferably at least 18 wt. %, preferably at least 19 wt. %, and preferably at least 20 wt. %, based on the total weight of the brine solution. As used herein, the term “chelating agent” refers to a chemical compound that can form multiple bonds with a single metal ion, resulting in a stable, ring-like structure known as a chelate complex. The chelating agent has multiple donor atoms (e.g., oxygen, nitrogen, sulfur, and the like) that can coordinate with the metal ion, effectively clawing the metal and preventing it from engaging in other chemical reactions. This multidentate binding increases the stability of the metal complex compared to simple, monodentate ligands. The chelating agent may include dimercaprol (2,3-dimercapto-1-propanol), diethylenetriaminepentaacetic acid (DTPA), hydroxyethylenediaminetriacetic acid (HEDTA), an ethylenediaminetetraacetic acid (EDTA), a combination thereof, and the like. In some embodiments, the chelating agent is an EDTA. In some embodiments, the chelating agent is an ethylenediaminetetraacetic acid disodium salt (Na-EDTA). The concentration of components of the brine solution may be varied to impart desired characteristics of the brine solution. In some embodiments, the brine solution comprises the chelating agent in an amount of 5 to 20 wt. % and CaCl₂) in an amount of 2 to 20 wt. %. In an embodiment, the brine solution comprises the chelating agent in an amount of about 20 wt. % and CaCl₂) in an amount of about 7.5 wt. %. In another embodiment, the brine solution comprises the chelating agent in an amount of about 10 wt. % and CaCl₂) in an amount of about 7.5 wt. %. In another embodiment, the brine solution comprises the chelating agent in an amount of about 20 wt. % and CaCl₂) in an amount of about 20 wt. %. In yet another embodiment, the brine solution comprises the chelating agent in an amount of about 10 wt. % and CaCl₂) in an amount of about 20 wt. %.

At step 104, the method 100 includes pressurizing the subterranean geological formation to a pressure of 20-2000 pounds per square inch (psi), preferably 50-1900 psi, preferably 100-1800 psi, preferably 200-1700 psi, preferably 300-1600 psi, preferably 400-1500 psi, preferably 500-1400 psi, preferably 600-1300 psi, preferably 700-1200 psi, preferably 800-1100 psi, and preferably 900-1000 psi with carbon dioxide (CO₂). In some embodiments, a combination of injection wells, compression systems, pressure monitoring, and/or reservoir management techniques may be employed to achieve a certain pressure in the subterranean geological formation. Pressurizing the subterranean geological formation may involve controlling the rate and pressure of a CO₂ injection to remain within the formation's capacity to avoid exceeding the formation's fracture pressure.

At step 106, the method 100 includes reacting the CO₂ with the CaCl₂) in the subterranean geological formation at a temperature of 20-90° C., preferably 25-85° C., preferably 30-80° C., preferably 35-75° C., preferably 40-70° C., preferably 45-65° C., and preferably 50-60° C., for 20-28 hours (h), preferably 21-27 h, preferably 22-26 h, more preferably 23-25 h, and yet more preferably about 24 h to form calcium carbonate (CaCO₃) in the subterranean geological formation.

In some embodiments, reacting the CO₂ with the CaCl₂) forms one or more selected from a group including calcite, vaterite, aragonite, and dolomite. In other embodiments, any carbonate minerals known in the art may be formed during the reacting of the CO₂ with the CaCl₂). In some embodiments, reacting the CO₂ with the CaCl₂) forms at least one calcite having a morphology selected from a group including spherical, prismatic, rhombohedral, scalenohedral, and amorphous. In alternate embodiments, other morphologies may exist such as cones, cuboidal, pyramidical, cylindrical, wires, crystals, rectangles, triangles, prisms, disks, cubes, ribbons, blocks, beads, discs, barrels, granules, whiskers, flakes, foils, powders, boxes, stars, flowers, polygonal (i.e., trigonal, pentagonal, hexagonal, and the like) mixtures thereof, and the like.

In some embodiments, the morphology is rhombohedral having rectangular particles with a longest dimension of 25-150 μm, preferably 30-145 μm, preferably 35-140 μm, preferably 40-135 μm, preferably 45-130 μm, preferably 50-125 μm, preferably 55-120 μm, preferably 60-115 μm, preferably 65-110 μm, preferably 70-105 μm, preferably 75-100 μm, preferably 80-95 μm, and preferably 85-90 μm, and fractures in the rectangular particles having a length of 20-100 μm, preferably 25-95 μm, preferably 30-90 μm, preferably 35-85 μm, preferably 40-80 μm, preferably 45-75 μm, preferably 50-70 μm, and preferably 55-65 μm. In some embodiments, the fractures in the rectangular particles have a width of 1-10 μm, preferably 2-9 μm, preferably 3-8 μm, and preferably 4-6 μm. In some embodiments, the fractures in the rectangular particles may have a varying width. In some embodiments, reacting the CO₂ with the CaCl₂) forms at least one calcite, and the morphology is rhombohedral having stacked rectangular particles. In some embodiments, reacting the CO₂ with the CaCl₂) forms at least one calcite, and the morphology is rhombohedral having fractures within the rhombohedral calcite.

In some embodiments, the morphology is scalenohedral having particles with a longest dimension of 10-130 μm, preferably 20-120 μm, preferably 30-110 μm, preferably 40-100 μm, preferably 50-90 μm, and preferably 60-80 μm, where the particles include layered flakes having the longest dimension of 5-20 μm, preferably 6-19 μm, preferably 7-18 μm, preferably 8-17 μm, preferably 9-16 μm, preferably 10-15 μm, preferably 11-14 μm, and preferably 12-13 μm. In some embodiments, the morphology is scalenohedral having particles and the particles have cracks, fractures, flakes, and/or striations. In a preferred embodiment, the morphology is scalenohedral having particles with an average diameter dimension of about 48.8 μm.

In some embodiments, the morphology is spherical having particles with a diameter of 2-15 μm, preferably 3-14 μm, preferably 4-13 μm, preferably 5-12 μm, preferably 6-11 μm, preferably 7-10 μm, and preferably 8-9 μm. In a preferred embodiment, the morphology is spherical having particles with an average diameter of about 7.8 μm. In some embodiments, the morphology is spherical having particles and the particles are agglomerated. In other embodiments, the morphology is spherical having particles with a diameter of 50-500 μm, preferably 100-400 μm, and preferably 200-300 μm.

In some embodiments, the morphology is prismatic having columnar particles with a longest dimension of 30-90 μm, preferably 35-85 μm, preferably 40-80 μm, preferably 45-75 μm, preferably 50-70 μm, preferably 55-65 μm and a diameter of 5-12 μm, preferably 6-11 μm, preferably 7-10 μm, and preferably 8-9 μm. In a preferred embodiment, the morphology is prismatic having columnar particles with an average length of about 53.3 μm and an average diameter of about 8.3 μm.

In some embodiments, 4 to 5 times, preferably 4.1 to 4.9 times, preferably 4.2 to 4.8 times, preferably 4.3 to 4.7 times, and preferably 4.4 to 4.6 times an amount of carbonate precipitate is formed at a temperature of 80° C. compared to the amount of carbonate precipitate formed at a temperature of 50° C. at a pressure of 50 psi and the chelating agent in an amount of 20 wt. %.

In some embodiments, the brine solution includes CaCl₂) in an amount of 7.5 wt. %, and 55-60 times, preferably 56-59-60 times, preferably 57-58 times, and preferably about 57.5 times an amount of carbonate precipitate is formed at a chelating agent amount of 15 wt. % compared to the amount of carbonate precipitate formed at a chelating agent amount of 5 wt. % at a temperature of 80° C. and at a pressure of 500 psi.

In some embodiments, the brine solution includes CaCl₂) in an amount of 10 wt. %, and 18-24 times, preferably 19-23 times, preferably 20-22 times, and preferably about 21 times an amount of carbonate precipitate is formed at a chelating agent amount of 15 wt. % compared to the amount of carbonate precipitate formed at a chelating agent amount of 5 wt. % at a temperature of 30° C. and at a pressure of 12-15 psi, preferably 13-14 psi.

In some embodiments, the brine solution includes CaCl₂) in an amount of 10 wt. %, and 5-10 times, preferably 6-9 times, and preferably 7-8 times an amount of carbonate precipitate is formed at a chelating agent amount of 15 wt. % compared to the amount of carbonate precipitate formed at a chelating agent amount of 5 wt. % at a temperature of 50° C. and at a pressure of 12-15 psi, and preferably 13-14 psi.

In some embodiments, the brine solution includes CaCl₂) in an amount of 10 wt. %, and 3-7 times, preferably 4-6 times, and preferably 5 times an amount of carbonate precipitate is formed at a chelating agent amount of 15 wt. % compared to the amount of carbonate precipitate formed at a chelating agent amount of 5 wt. % at a temperature of 50° C. and at a pressure of 500 psi.

In some embodiments, the brine solution includes CaCl₂) in an amount of 20 wt. % and the chelating agent in an amount of 10 wt. %, and 100-110 times, preferably 101-109 times, preferably 102-108 times, preferably 103-107 times, preferably 104-106 times, and preferably about 105 times an amount of carbonate precipitate is formed at a pressure of 1500 psi compared to the amount of carbonate precipitate formed at a pressure of 100 psi at a temperature of 50° C.

In some embodiments, the brine solution includes CaCl₂) in an amount of 20 wt. % and the chelating agent in an amount of 10 wt. %, and forms 2.12 g and 0.02 g of carbonate precipitate at pressure of 1500 and 50 psi, respectively, at 50° C.

In some embodiments, the brine solution includes CaCl₂) in an amount of 20 wt. % and the chelating agent in an amount of 10 wt. %, and the carbonate precipitate formed includes aragonite in an amount of 3-5 wt. %, preferably 3.5-4.5 wt. %, and more preferably about 4.4 wt. %, calcite in an amount of 80-85 wt. %, preferably 81-83 wt. %, and more preferably about 82.9 wt. %, vaterite in an amount of 11-13 wt. %, preferably 11.5-12.5 wt. %, and more preferably about 12.0 wt. %, and halite in an amount of 0.5-1 wt. %, preferably 0.6-0.9 wt. %, and more preferably about 0.7 wt. %, based on a total weight of the carbonate precipitate formed at a pressure of 50 psi and a temperature of 80° C.

In some embodiments, the brine solution includes CaCl₂) in an amount of 20 wt. % and the chelating agent in an amount of 10 wt. %, and the carbonate precipitate formed includes calcite in an amount of 75-85 wt. %, preferably 76-84 wt. %, preferably 77-83 wt. %, preferably 78-82 wt. %, preferably 79-81 wt. %, and yet more preferably 80.1 wt. % and vaterite in an amount of 15-25 wt. %, preferably 16-24 wt. %, preferably 17-23 wt. %, preferably 18-22 wt. %, more preferably 19-21 wt. %, and yet more preferably about 19.9 wt. % vaterite, based on a total weight of the carbonate precipitate formed at a pressure of 500 psi and a temperature of 80° C.

In some embodiments, the brine solution includes CaCl₂) in an amount of 20 wt. % and the chelating agent in an amount of 10 wt. %, and the carbonate precipitate formed includes aragonite in an amount of 3-6 wt. %, preferably 4-5 wt. %, and yet more preferably about 4.5 wt. %, calcite in an amount of 20-30 wt. %, preferably 21-29 wt. %, preferably 22-28 wt. %, preferably 23-27 wt. %, more preferably 24-26 wt. % and yet more preferably about 24.8 wt. %, vaterite in an amount of 1-5 wt. %, preferably 2-4 wt. %, more preferably 2.5-3.5 wt. %, and yet more preferably about 2.8 wt. %, and halite in an amount of 65-70 wt. %, preferably 66-69 wt. %, more preferably 67-68 wt. %, and yet more preferably 67.9 wt. %, based on a total weight of the carbonate precipitate formed at a pressure of 1000 psi and a temperature of 80° C.

### Examples

The following examples describe and demonstrate a method of carbon dioxide (CO₂) mineralization by injecting a brine solution into a subterranean geological formation. The examples are provided solely for illustration and are not to be construed as limitations of the present disclosure, as many variations are possible without departing from the spirit and scope of the present disclosure.

### Example 1: Materials

The salts used in the present disclosure to prepare the brine solution/composition are of ACS reagent grade and include sodium chloride (NaCl), sodium bicarbonate (NaHCO₃), sodium sulfate (Na₂SO₄), magnesium chloride (MgCl₂), and calcium chloride (CaCl₂)). Table 1 lists the brine compositions of sea water (SW) and formation water (FW) containing sodium (Na⁺), calcium (Ca²⁺), magnesium (Mg²⁺), sulfate (SO₄²⁻), chloride (Cl⁻), and bicarbonate (HCO₃⁻), with total dissolved solids (TDS) values in parts per million (ppm). The CO₂ gas used in the present disclosure is of 99.99% purity as supplied. Additionally, for the assessment of mineralization of CO₂ in brine systems, a chelating agent, ethylenediaminetetraacetic acid (EDTA), supplied by Sigma Aldrich was used as received.

TABLE 1
Brine composition

Concentration (ppm)

| Ions | SW | FW |
|---|---|---|
| Na⁺ | 18,300 | 59,491 |
| Ca²⁺ | 650 | 19,040 |
| Mg²⁺ | 2,110 | 2,439 |
| SO₄²⁻ | 4,290 | 350 |
| Cl⁻ | 32,200 | 132,060 |
| HCO₃⁻ | 120 | 354 |
| TDS | 57,670 | 213,734 |

### Example 2: Methodology

Deionized (DI) water, CaCl₂) solutions with concentrations of 7.5 percent by weight (wt. %) and 20 wt. %, seawater (SW), and formation water (FW) (compositions listed in Table 1) were used in CO₂ mineralization in fluid systems. Mineralization processes often involve divalent cations in brine; therefore, CaCl₂) solutions were utilized. CO₂ solubility in CaCl₂) and MgCl₂ solutions differ very little, thus, CaCl₂) was used for mineralization. SW and FW are used to evaluate mineralization in fluids with various salt levels, and to establish a minimum concentration of divalent cations (Ca²⁺) to achieve the conversion to CaCO₃.

DI water, CaCl₂) solution (7.5 wt. % and 20 wt. %), SW, and FW were used to determine mineralization. About 50 milliliters (mL) of fluid in the case of DI water, CaCl₂, SW, and FW were measured and poured into an ageing cell of 250 mL volume. The cells were closed using a cover lid. The cell was further vacuumed for three minutes to remove air from the cell and carbon dioxide gas was introduced into the cell to the experimental pressure. The evaluated pressures were 50 pounds per square inch (psi), 100 psi, 500 psi, 1000 psi, and 1500 psi. Although pressures in reservoirs may be higher than the pressures evaluated, more mineralized carbonate may be generated under the evaluated pressures. Mineralization was evaluated at ambient temperature and atmospheric pressure. Once the desired pressure was reached, the valve was closed, and the cell was removed from the setup. The procedure was repeated with five cells. The cells were placed in an oven at a desired temperature for 24 hours (h). The effect of temperature on CO₂ mineralization was examined with temperatures of 30 degrees Celsius (° C.), 50° C., and 80° C. The cells were recovered from the oven after being aged for 24 h, and the same apparatus that was used to pressurize the cells was utilized to measure an equilibrium pressure in each cell. The cells were gradually degassed with a valve until no more gas was discharged. The pH, conductivity, and total inorganic carbon content (TIC) of the gas-free liquid was measured after the cells were opened.

Presence of a precipitate was ascertained by visual inspection. When precipitates were found, they were retrieved and dried at 40° C. to avoid morphological transformations. The precipitates, after being dried (at 40° C. and atmospheric pressure), were then characterized using X-ray diffraction (XRD) and scanning electron microscope (SEM).

To investigate the impact of additives (such as EDTA), 25 mL of EDTA was added to 50 mL of fluid (CaCl₂) solutions, SW, and FW). The cells were vacuum sealed and pressurized as before. The pH values of the fluids before and after reaching equilibrium were recorded. pH informs about speciation of CO₂ (CO₂, HCO₃″, and CO₃²⁻) that exists at equilibrium conditions. The presence of carbonate was also ascertained and characterized as above. X-ray powder diffraction (XRD) of the samples was conducted using a Rigaku Ultima IV.

In some examples, a total of 12 post-experiment samples were investigated using a Gemini 450 scanning electron microscope, which was fitted with a Bruker Quantax energy dispersive X-ray spectrometer and a backscattered electron detector. Prior to scanning electron microscope analysis, prepared stub-mounted samples were twice coated with 30 nanometers (nm) of gold-palladium using a Quorum QR150R sputter coater. The coated samples were investigated under scanning electron microscope at 15 kilovolts (kV) and 166 picoampere (pA) probe current, at a working distance ranging from 8 nm to 15 mm. Nine out of the 34 precipitate samples that were recovered from the experimentations were subjected to scanning electron microscopy (SEM) . . . . XRD was used to analyze the mineralogical composition of the materials.

CO₂ gas was introduced to each of the examined fluids at three temperatures (30° C., 50° C., and 80° C.) and various pressures ranging from 50 psi to 1500 psi. Conductivity, pH, and TIC of the equilibrium fluids were determined in each sample. It may be noted that DI water lacks divalent cations for mineralization, hence no precipitates were seen in any of the instances in which DI water was exposed to CO₂ at the experimental pressures and temperatures. The CaCl₂) solutions, SW, and FW did not produce any carbonates when exposed to CO₂ gas under the experimental pressure and temperature conditions. CaCO₃ precipitates were seen when EDTA was added to the CaCl₂) solutions, SW, and FW.

The precipitation of CaCO₃ was evaluated in the presence of EDTA at 10 wt. % and 20 wt. %, in solutions containing 7.5 wt. % and 20 wt. % CaCl₂). Table 2 lists precipitates in the case of 7.5 wt. % CaCl₂) solution. 50 mL of the fluid (CaCl₂) solution, SW or FW) was added to 25 mL of the EDTA solution and CO₂ gas was exposed to the mixture at various pressures and temperatures. The cells were degassed and opened to expose the precipitated CaCO₃ after they had aged for 24 h in the oven. Each instance in which precipitates were generated involved drying and weighing the precipitates to determine a mass of the precipitates. Furthermore, the precipitates were characterized using SEM and XRD investigation.

No precipitates were formed when a 10 wt. % EDTA solution was added to a 7.5 wt. % CaCl₂) solution at 30° C. and 50° C. At 80° C., the first precipitates from the 7.5 wt. % CaCl₂) solution and the 10 wt. % EDTA solution were seen. Table 2 shows that at 80° C., the amount of precipitate formed as a function of pressure was 1.22 grams (g), 1.92 g, and 1.28 g for 500 psi, 1000 psi, and 1500 psi, respectively. Precipitates did not form at lower pressures of 50 psi and 100 psi. At lower concentrations of EDTA (about 10 wt. %), precipitate formation is dependent on both temperature and pressure. When the EDTA concentration was raised to 20 wt. %, precipitates were seen at every temperature examined (30° C., 50° C., and 80° C.), as well as at every pressure ranging from 50 psi to 1500 psi. The concentration of the EDTA solution has an impact on the formation of precipitates. In the case of the temperatures examined, the mass of the precipitates formed increase 5 with pressure. A larger number of precipitates may occur in situ given that the reservoir pressures are higher than those examined in the present disclosure. The minimum temperature for carbonate precipitation to occur in the instance of the 7.5 wt. % CaCl₂) solution and the 10 wt. % EDTA is 80° C., and the minimum pressure is 500 psi at 80° C. At higher concentrations of EDTA, CaCO₃ precipitation occurs at all pressures and temperatures.

TABLE 2
Precipitates in the case of 7.5 wt. % CaCl₂ solution

| CaCl₂ | EDTA | Pressure | Temperature | Precipitate Weight |
|---|---|---|---|---|
| (wt. %) | (wt. %) | (psi) | (° C.) | (g) |
| 7.5 | 10 | 500 | 80 | 1.22 |
| 7.5 | 10 | 1000 | 80 | 1.92 |
| 7.5 | 10 | 1500 | 80 | 1.28 |
| 7.5 | 20 | 50 | 30 | 1.72 |
| 7.5 | 20 | 100 | 30 | 1.54 |
| 7.5 | 20 | 500 | 30 | 1.66 |
| 7.5 | 20 | 1000 | 30 | 2.85 |
| 7.5 | 20 | 1500 | 30 | 2.80 |
| 7.5 | 20 | 50 | 50 | 2.94 |
| 7.5 | 20 | 100 | 50 | 2.49 |
| 7.5 | 20 | 500 | 50 | 2.85 |
| 7.5 | 20 | 1000 | 50 | 2.82 |
| 7.5 | 20 | 1500 | 50 | 3.02 |
| 7.5 | 20 | 50 | 80 | 1.67 |
| 7.5 | 20 | 100 | 80 | 2.22 |
| 7.5 | 20 | 500 | 80 | 2.24 |
| 7.5 | 20 | 1000 | 80 | 2.21 |
| 7.5 | 20 | 1500 | 80 | 2.28 |

Table 3 lists the mass of precipitates formed for 20 wt. % CaCl₂) solutions. The minimum temperature needed for precipitates to form in the case of 20 wt. % CaCl₂) solutions and 10 wt. % EDTA is 50° C., whereas the 7.5 wt. % CaCl₂) solutions needed a temperature of 80° C. At 50° C., the mass of precipitates was low at pressures as high as 1000 psi, reaching maximum value at 1500 psi. This indicates that the concentration of EDTA may impact carbonate production, in addition to the concentration of Ca²⁺. The mass of precipitates in the case of the 20 wt. % CaCl₂) solution is twice that of the 7.5 wt. % CaCl₂) solution at 80° C. and 10 wt. % EDTA, as listed in Table 3 and Table 2, respectively. Higher precipitate masses were observed in the cases with 20 wt. % EDTA, 5 with some cases recording a value of almost 7 g.

TABLE 3
Precipitates with a 20 wt. % CaCl₂ solution

| CaCl₂ | EDTA | Pressure | Temperature | Precipitate weight |
|---|---|---|---|---|
| (wt. %) | (wt. %) | (psi) | (° C.) | (g) |
| 20 | 10 | 100 | 50 | 0.02 |
| 20 | 10 | 500 | 50 | 0.08 |
| 20 | 10 | 1000 | 50 | 0.43 |
| 20 | 10 | 1500 | 50 | 2.12 |
| 20 | 10 | 50 | 80 | 2.85 |
| 20 | 10 | 100 | 80 | 2.75 |
| 20 | 10 | 500 | 80 | 2.98 |
| 20 | 10 | 1000 | 80 | 2.89 |
| 20 | 10 | 1500 | 80 | 2.56 |
| 20 | 20 | 50 | 30 | 5.86 |
| 20 | 20 | 100 | 30 | 6.40 |
| 20 | 20 | 500 | 30 | 6.11 |
| 20 | 20 | 1000 | 30 | 6.86 |
| 20 | 20 | 1500 | 30 | 5.29 |
| 20 | 20 | 50 | 50 | 6.84 |
| 20 | 20 | 100 | 50 | 7.15 |
| 20 | 20 | 500 | 50 | 6.94 |
| 20 | 20 | 1000 | 50 | 6.78 |
| 20 | 20 | 1500 | 50 | 7.02 |
| 20 | 20 | 50 | 80 | 5.50 |
| 20 | 20 | 100 | 80 | 5.82 |
| 20 | 20 | 500 | 80 | 5.57 |
| 20 | 20 | 1000 | 80 | 5.96 |
| 20 | 20 | 1500 | 80 | 6.09 |

Precipitates formed with 20 wt. % EDTA and 7.5 wt. % and 20 wt. % CaCl₂) solutions under atmospheric conditions are listed in Table 4. CaCO₃ precipitates with 20 wt. % EDTA at atmospheric conditions. Other ionic chlorides, such as MgCl₂, and may create similar carbonates to CaCl₂) because Mg²⁺ and Ca²⁺ have the same charge (2+); therefore, brines containing large quantities of divalent cations are candidates for CO₂ mineralization. Rejected water from water treatment methods, such as reverse osmosis, is another approach for CO₂ mineralization since the rejected water includes a high concentration of divalent cations which, when paired with CO₂ and EDTA, may be transformed into carbonates.

TABLE 4
Precipitates at atmospheric conditions

| CaCl₂ | EDTA | Pressure | Temperature | Precipitate |
|---|---|---|---|---|
| (wt. %) | (wt. %) | (psi) | (° C.) | Weight (g) |
| 7.5 | 20 | Atmospheric | Room temperature | 0.46 |
| 20 | 20 | Atmospheric | Room temperature | 0.51 |

The ability of sea water (SW) and formation water (FW) to form carbonates under identical experimental conditions was assessed and results indicated that no precipitate was formed in the case of SW at any pressure, temperature, or EDTA concentration. This may be due to the low Ca²⁺ concentration in SW, as listed in Table 1, which is used in producing carbonate ions. Table 5 lists precipitates formed with FW. Precipitates were only formed with FW with 20 wt. % EDTA at low pressures and between 50° C. and 80° C. Brines occurring naturally in reservoirs may not contain enough Ca²⁺ for the formation of carbonate; therefore, concentrations of CaCl₂) were evaluated. Carbonate precipitates were formed with a 5 wt. % CaCl₂) solution concentration. To choose CO₂ mineralization sites, a map of all brine sources may be needed.

TABLE 5
Precipitates with FW

| | EDTA | Pressure | Temperature | Precipitate Weight |
|---|---|---|---|---|
| Fluid | (wt. %) | (psi) | (° C.) | (g) |
| FW | 20 | 50 | 50 | 0.29 |
| FW | 20 | 100 | 50 | 0.10 |
| FW | 20 | 50 | 80 | 1.41 |

X-ray diffraction (XRD) analysis was performed on the samples to determine the mineralogical composition of the precipitates. Mineralogy XRD analysis results for the 7.5 wt. % CaCl₂) solution are listed in Table 6. Mineralogy XRD analysis results for the 20 wt. % CaCl₂ solution are listed in Table 7. Mineralogy XRD analysis results for precipitates formed at atmospheric conditions are listed in Table 8. Table 9 lists mineralogy results for XRD analysis of precipitates formed with FW. The main mineralogy found in the precipitates of CaCl₂) solutions was calcite. Different morphologies of calcium carbonates were examined. Halite was also detected due to the breakdown of the Na-EDTA molecule. The presence of halite may be the result of a reaction between Cl from the CaCl₂) solution and Na⁺ from Na-EDTA. A majority of CaCl₂) examples indicate that calcite dominates as the main mineral formed in the precipitates. Calcite is the most thermodynamically stable of the three carbonate morphologies (vaterite, aragonite, and calcite). As can be seen from Table 8, most of the precipitates are calcite at atmospheric conditions suggesting that the method described herein may be used in surface mineralization to produce stable carbonate. In contrast to pressurized systems, the mass of precipitates is smaller at surface and/or atmospheric conditions.

As can be seen from Table 9, dolomite and calcite were two abundant minerals found in the precipitates of FW, which also contain additional salts besides CaCl₂). In addition to calcite, dolomite production is conceivable in saline aquifers and reservoirs water high in Mg²⁺. In addition, the XRD data demonstrates that the method described in accordance with the present disclosure may produce carbonate minerals in less than a (one) day (24 hours).

TABLE 6
XRD analysis of precipitates in the case of 7.5 wt. % CaCl₂ solution

| CaCl₂ | EDTA | Pressure | Temperature | Mineralogy (%) | | | |
|---|---|---|---|---|---|---|---|
| (wt. %) | (wt. %) | (psi) | (° C.) | Aragonite | Calcite | Vaterite | Halite |
| 7.5 | 10 | 500 | 80 | 84.9 | 0.0 | 15.1 | 0.0 |
| 7.5 | 10 | 1000 | 80 | 0.0 | 0.0 | 3.3 | 96.7 |
| 7.5 | 10 | 1500 | 80 | 0.0 | 0.0 | 98.2 | 1.8 |
| 7.5 | 20 | 50 | 30 | 0.4 | 98.5 | 1.1 | 0.0 |
| 7.5 | 20 | 100 | 30 | 0.0 | 96.7 | 0.5 | 2.8 |
| 7.5 | 20 | 500 | 30 | 0.0 | 94.1 | 0.5 | 5.4 |
| 7.5 | 20 | 1000 | 30 | 0.0 | 92.8 | 2.1 | 5.1 |
| 7.5 | 20 | 1500 | 30 | 0.6 | 94.0 | 2.6 | 2.8 |
| 7.5 | 20 | 50 | 50 | 79.6 | 20.4 | 0.0 | 0.0 |
| 7.5 | 20 | 100 | 50 | 10.2 | 89.0 | 0.8 | 0.0 |
| 7.5 | 20 | 500 | 50 | 6.4 | 47.8 | 45.8 | 0.0 |
| 7.5 | 20 | 1000 | 50 | 0.0 | 97.2 | 1.7 | 1.1 |
| 7.5 | 20 | 1500 | 50 | 23.9 | 72.7 | 3.0 | 0.4 |
| 7.5 | 20 | 50 | 80 | 0.0 | 70.3 | 2.2 | 27.5 |
| 7.5 | 20 | 100 | 80 | 0.0 | 38.0 | 1.5 | 60.5 |
| 7.5 | 20 | 500 | 80 | 0.0 | 60.5 | 2.4 | 37.1 |
| 7.5 | 20 | 1000 | 80 | 0.0 | 60.2 | 0.5 | 39.3 |
| 7.5 | 20 | 1500 | 80 | 0.0 | 51.3 | 1.2 | 47.5 |

TABLE 7
XRD analysis of precipitates in the case of 20 wt. % CaCl₂ solution

| CaCl₂ | EDTA | Pressure | Temperature | Mineralogy (%) | | | |
|---|---|---|---|---|---|---|---|
| (wt. %) | (wt. %) | (psi) | (° C.) | Aragonite | Calcite | Vaterite | Halite |
| 20 | 10 | 100 | 50 | 0.0 | 98.4 | 1.6 | 0.0 |
| 20 | 10 | 500 | 50 | 0.0 | 46.6 | 36.4 | 17.0 |
| 20 | 10 | 1000 | 50 | 41.7 | 57.8 | 0.4 | 0.1 |
| 20 | 10 | 1500 | 50 | 95.3 | 2.8 | 0.7 | 1.2 |
| 20 | 10 | 50 | 80 | 4.4 | 82.9 | 12.0 | 0.7 |
| 20 | 10 | 100 | 80 | 1.1 | 47.2 | 49.2 | 2.5 |
| 20 | 10 | 500 | 80 | 0.0 | 80.1 | 19.9 | 0.0 |
| 20 | 10 | 1000 | 80 | 4.5 | 24.8 | 2.8 | 67.9 |
| 20 | 10 | 1500 | 80 | 0.0 | 96.1 | 2.2 | 1.7 |
| 20 | 20 | 50 | 30 | 0.0 | 94.0 | 5.2 | 0.8 |
| 20 | 20 | 100 | 30 | 0.0 | 82.6 | 14.4 | 3.0 |
| 20 | 20 | 500 | 30 | 9.7 | 90.3 | 0.0 | 0.0 |
| 20 | 20 | 1000 | 30 | 97.9 | 2.1 | 0.0 | 0.0 |
| 20 | 20 | 1500 | 30 | 0.0 | 62.4 | 1.1 | 36.5 |
| 20 | 20 | 50 | 50 | 14.7 | 74.0 | 2.5 | 8.8 |
| 20 | 20 | 100 | 50 | 0.0 | 93.7 | 2.2 | 4.1 |
| 20 | 20 | 500 | 50 | 0.0 | 59.7 | 0.4 | 39.9 |
| 20 | 20 | 1000 | 50 | 0.0 | 94.4 | 1.0 | 4.6 |
| 20 | 20 | 1500 | 50 | 0.0 | 65.3 | 3.9 | 30.8 |
| 20 | 20 | 50 | 80 | 0.0 | 60.8 | 0.3 | 38.9 |
| 20 | 20 | 100 | 80 | 0.0 | 98.4 | 1.6 | 0.0 |
| 20 | 20 | 500 | 80 | 0.0 | 46.6 | 36.4 | 17.0 |
| 20 | 20 | 1000 | 80 | 41.7 | 57.8 | 0.4 | 0.1 |
| 20 | 20 | 1500 | 80 | 95.3 | 2.8 | 0.7 | 1.2 |

TABLE 8
XRD analysis of precipitates at atmospheric conditions

| CaCl₂ | EDTA | Pressure | Temperature | Mineralogy (%) | | | |
|---|---|---|---|---|---|---|---|
| (wt. %) | (wt. %) | (psi) | (° C.) | Aragonite | Calcite | Vaterite | Halite |
| 7.5 | 20 | Atmospheric | Room | 0.8 | 95.6 | 1.3 | 2.3 |
| | | | Temperature | | | | |
| 20 | 20 | Atmospheric | Room | 0.0 | 95.5 | 0.5 | 4.0 |
| | | | Temperature | | | | |

TABLE 9
XRD analysis of precipitates in the case of FW

| | EDTA | Pressure | Temperature | Mineralogy (%) | | | |
|---|---|---|---|---|---|---|---|
| Fluid | (wt. %) | (psi) | (° C.) | Aragonite | Calcite | Dolomite | Halite |
| FW | 20 | 50 | 50 | 0.0 | 0.0 | 100.0 | 0.0 |
| FW | 20 | 100 | 50 | 0.0 | 8.2 | 49.3 | 42.6 |

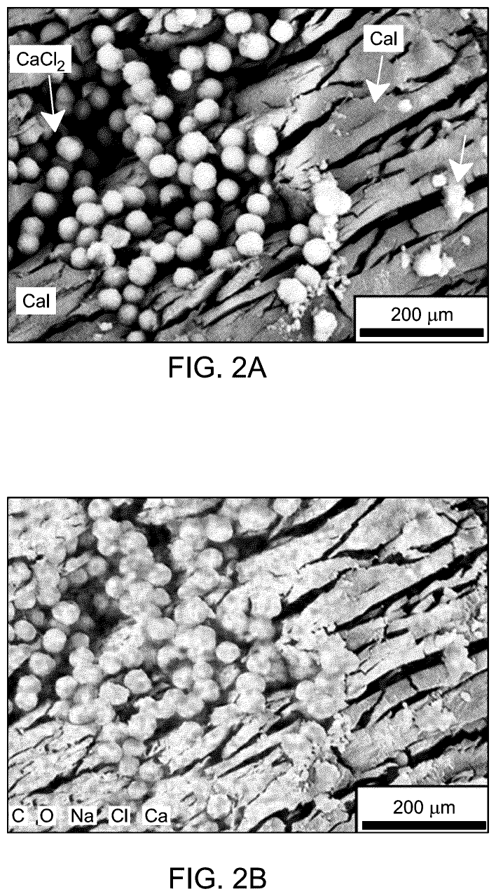

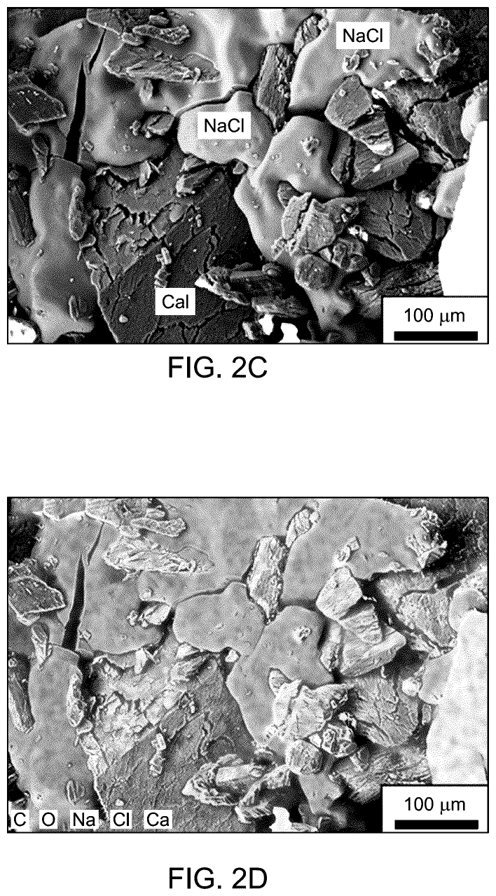

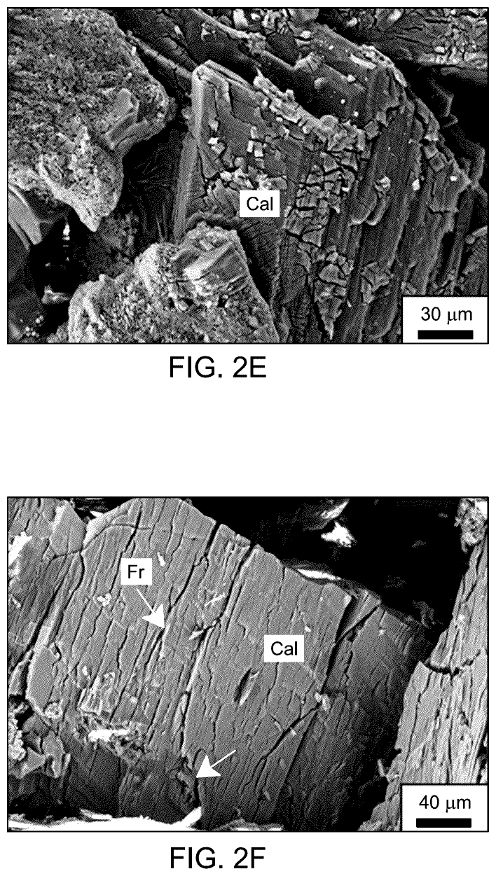

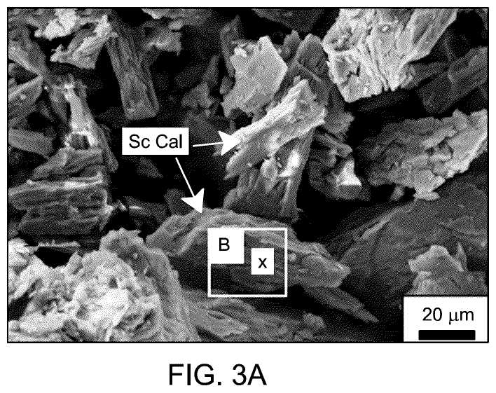

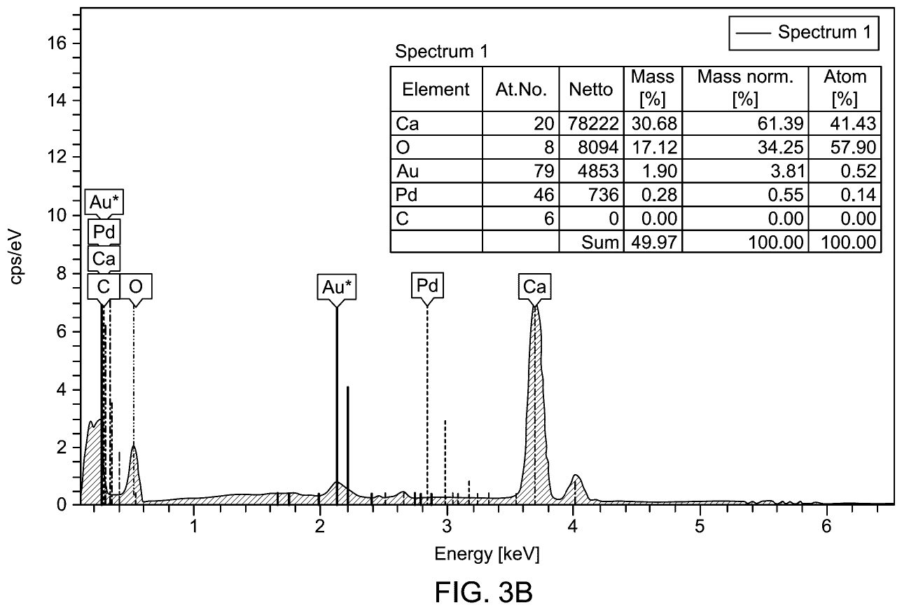

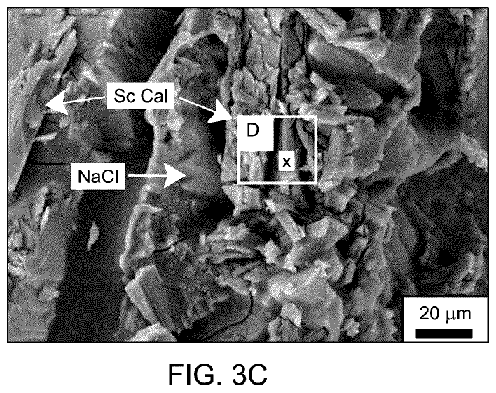

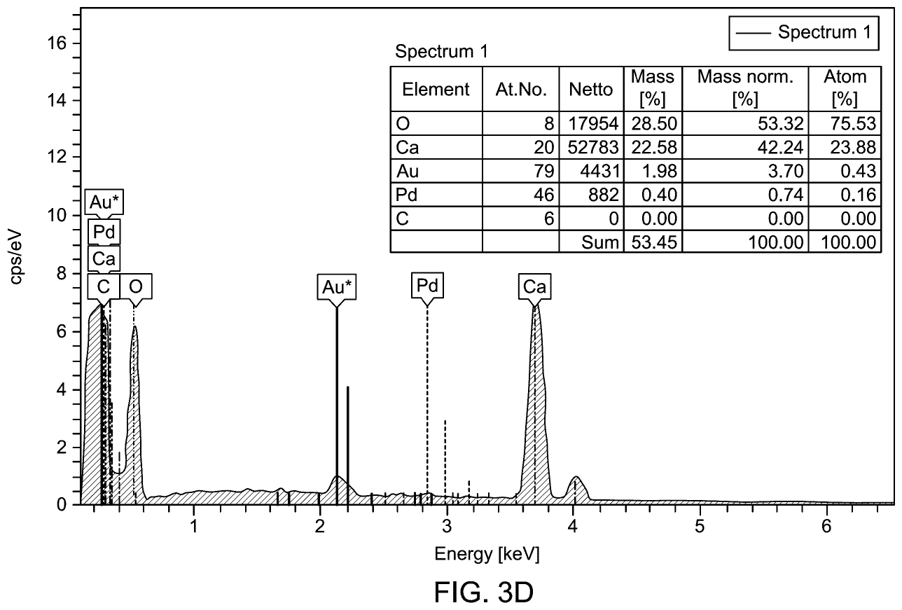

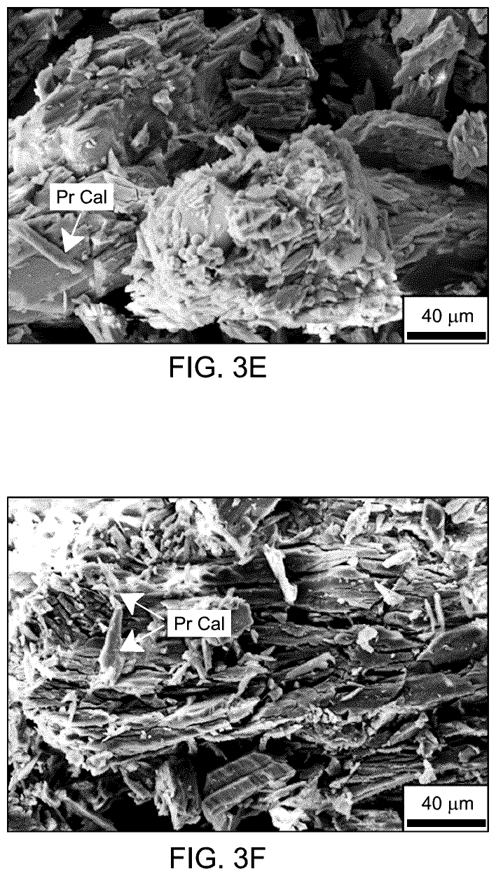

SEM images and EDX analyses of the precipitates are illustrated in FIGS. 2A-2F and FIGS. 3A-3F. SEM analysis of the samples was conducted to determine the morphology of the precipitates. The synthesized calcite (Cal) crystals exhibit five types of crystal forms including rhombohedral, scalenohedral, prismatic, spherical, and amorphous crystal shapes. The rhombohedral calcite has a rhombic crystal shape and is a dominant crystal morphology of the precipitated calcite samples. The rhombohedral calcite has a diameter ranging from about 27.2 μm to 138.6 μm. The rhombohedral calcite is commonly associated with dissolutions of both CaCl₂, as shown in FIGS. 2A-2B and NaCl, as shown in FIGS. 2C-2D. In both cases, the rhombohedral calcite replaces partly pervasively dissolved CaCl₂) and NaCl crystals. The NaCl herein is from the reaction of Na from the Na-EDTA used and the chloride from the CaCl₂). This corroborates the XRD results in the cases of CaCl₂) solutions. FIG. 2A depicts that the spherical CaCl₂) loses its form and gets incorporated into the crystal structure of the precipitated calcite. FIG. 2B is an EDX elemental map of the rhombohedral calcite crystals, depicting a distribution of calcium (Ca), sodium (Na), carbon (C), chlorine (Cl), and oxygen (O), in the rhombohedral calcite crystals. FIG. 2C is an SEM image of replacement of partially dissolved NaCl by rhombohedral calcite, and FIG. 2D is an EDX elemental map of partially dissolved NaCl depicting the distributions of Ca, Na, C, Cl, and O. The rhombohedral calcites include stacked, well-developed calcite rhombs, as shown by the SEM image in FIG. 2E. Calcite rhombs are commonly characterized by abundant cleavages and fractures (Fr), as shown in FIG. 2F, which depicts an SEM image of fractures within the rhombohedral calcite.

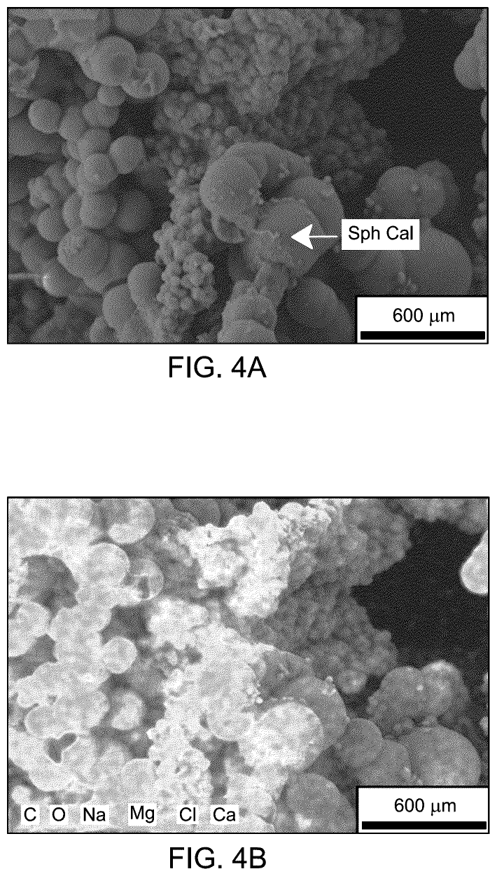

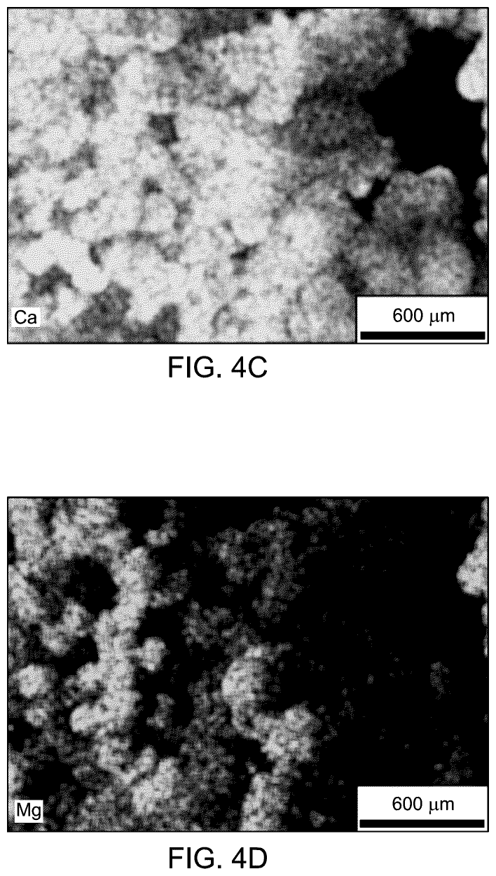

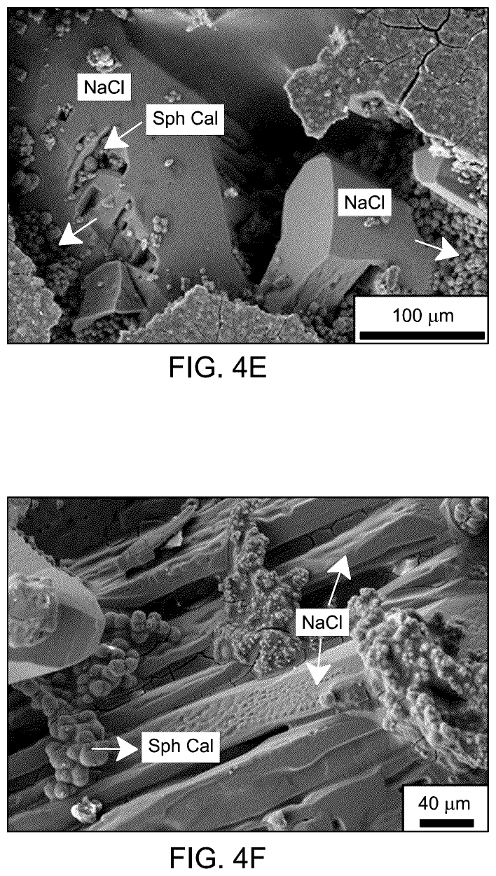

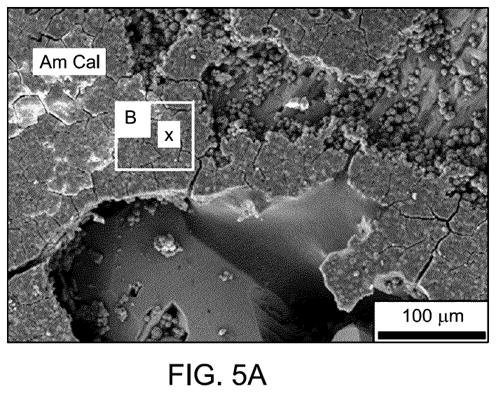

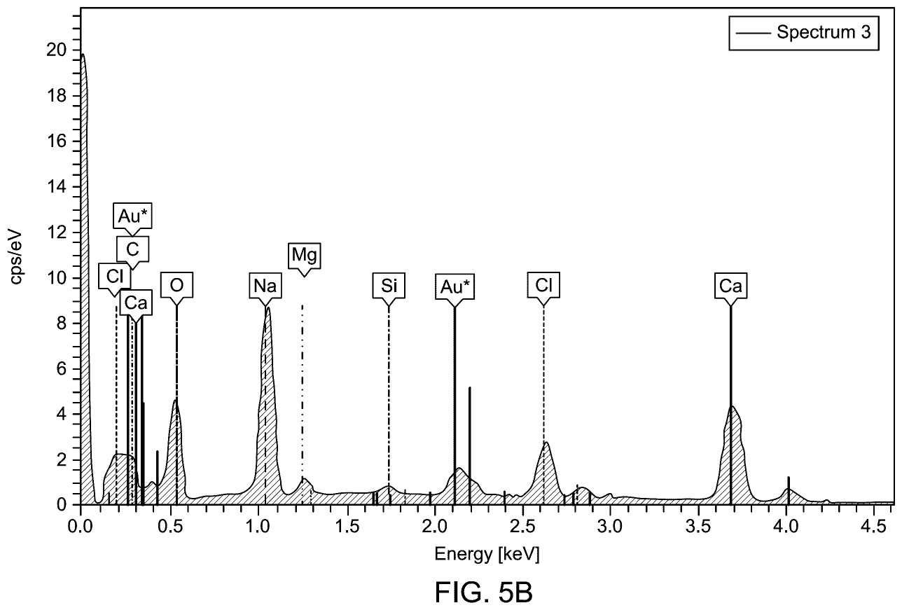

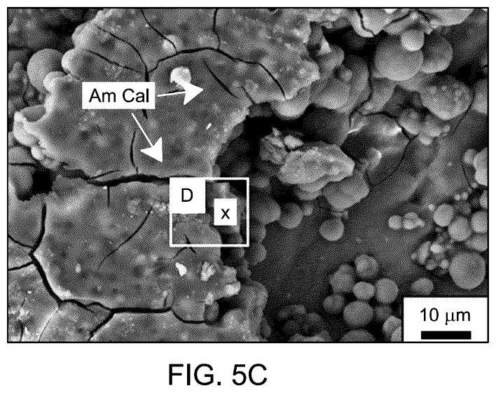

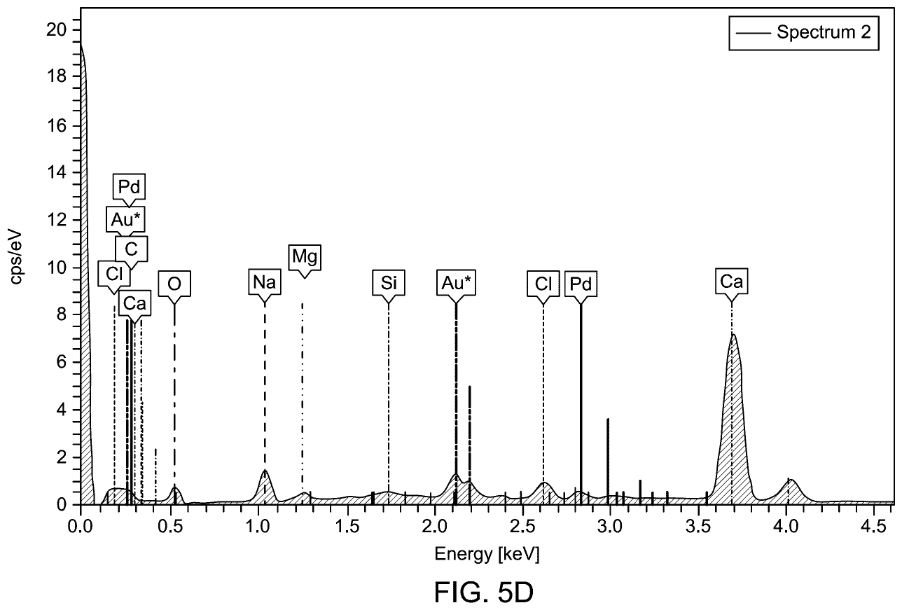

The second dominant morphology of calcite found in the samples is scalenohedral morphology. Scalenohedral calcites (Sc Cal) are elongated forms of rhombohedral-shaped calcite, as shown in FIGS. 3A-3D. Scalenohedral calcites have a diameter ranging from about 16.4 μm to 124.8 μm. As can be seen from FIG. 3C, the scalenohedral calcite commonly occurs as complete replacements of dissolved NaCl. In addition, prismatic calcite (Pr Cal), which exhibits columnar or rod-like morphological features, is observed in the precipitated samples, as shown in FIGS. 3E-3F. Prismatic calcite occurs as the least abundant crystal shape in the precipitated calcite crystals with length varying from about 32.2 μm to 87.9 μm, and a diameter ranging from about 6.0 μm to 10.5 μm. Spherical calcite (Sph Cal) is the third most dominant crystal shape observed in the analyzed calcites, with a diameter ranging from about 3.4 μm to 12.0 μm. The spherical form of the analyzed calcites incorporate both calcium and magnesium in its crystal structure, as shown in FIGS. 4A-4D. EDX analysis shows that atomic abundance of magnesium in the spherical calcite ranges between 0.65% to 1.88%. Spherical calcite is commonly associated with partly dissolved NaCl and infills both isolated-dissolution holes (FIG. 4E) and fibrous-dissolution holes (FIG. 4F) within NaCl crystals. Amorphous calcite (Am Cal) is also found in the precipitates. Amorphous calcite lacks definite crystal form and forms due to incomplete replacement of dissolved NaCl crystals, as shown in FIG. 5A and FIG. 5C. EDX analysis shows that the crystal structure of amorphous calcite is characterized by the presence of both Ca and Na, as shown in FIG. 5B and FIG. 5D. All precipitates are calcite, which is the most stable of carbonate morphologies.

Subsurface storage of CO₂ in subterranean geological formations may be possible at ambient conditions as well as conditions differing from ambient conditions (i.e., subterranean geological formation conditions).

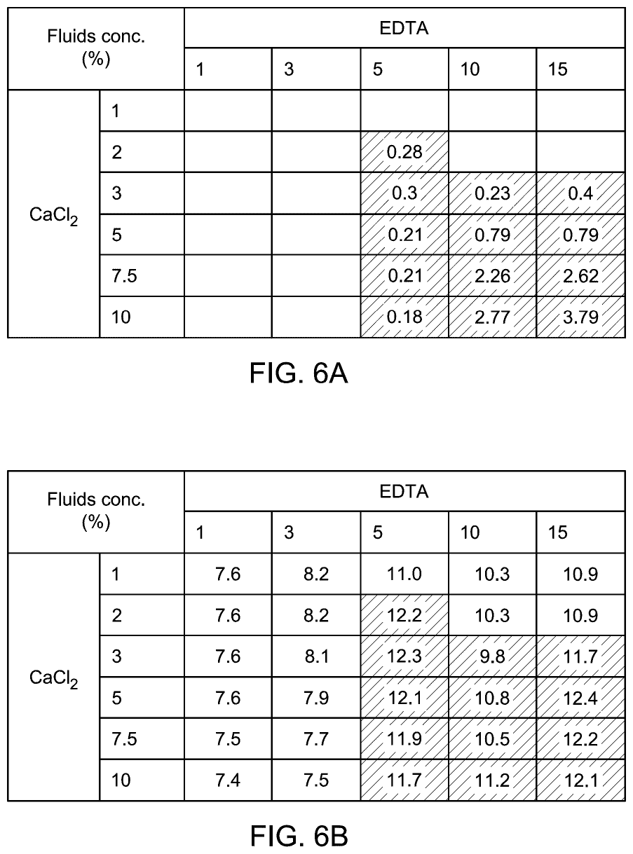

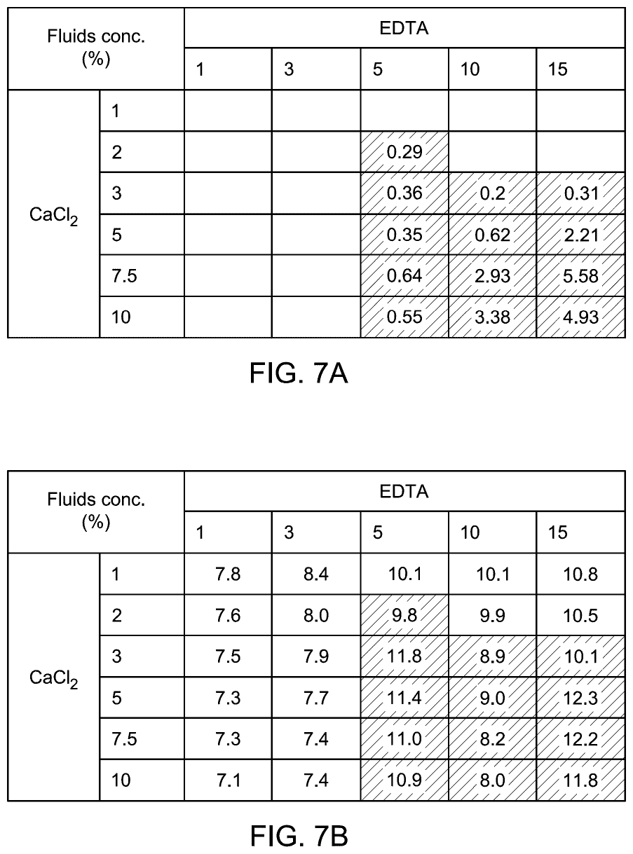

FIGS. 6A-6B and FIGS. 7A-7B depict surface mineralization of CO₂. FIGS. 6A-6B and FIGS. 7A-7B depict combinations of CaCl₂) and EDTA solutions at different concentrations and a temperature of 30° C. and 50° C., respectively. Conditions at which mineralization is not possible are depicted as blank boxes in FIG. 6A and FIG. 6B. Conditions at which precipitates are formed contain a number in FIG. 6A and FIG. 6B. Minimum cation concentrations for mineralization at 30° C. with atmospheric pressure is shown in FIG. 6A. At temperatures of 30° C. and 50° C., the same concentration of CaCl₂) (2 wt. % to 10 wt. %) and EDTA (5 wt. % to 15 wt. %) achieves mineralization, as shown in FIG. 6A and FIG. 7A, respectively. During surface mineralization, CO₂ absorption from the atmosphere is gradual. In both temperature instances, a minimum of 2 wt. % CaCl₂) concentration is needed for mineralization to be achieved. To improve the kinetics of mineralization such that it is completed within 24 h, an EDTA concentration of 5 wt. % is needed. This implies that temperature does not greatly affect a minimum concentration of CaCl₂ and EDTA for mineralization; however, temperature does impact the amount of precipitate that may be formed (increased precipitate mass with increase in temperature). The mass of precipitates formed in each case is denoted by the values in the cells of FIG. 6A and FIG. 7A. From these values, it may be observed that the mass of precipitates formed increases with an increase in concentration of CaCl₂) solution concentration, except at 30° C. and an EDTA concentration of 5 wt. %. At a given CaCl₂) concentration, an increase in the concentration of EDTA increases the mass of precipitates formed. Mineralization of CO₂ is dependent on the concentration of salts in brines. In surface mineralization of CO₂, there may be less control over the number of cations from water sources. FIG. 6B and FIG. 7B depict that pH is a factor in CO₂ mineralization. From FIG. 6B and FIG. 7B, it may be observed that at all conditions, the equilibrium pH is about or above 8.0, yet mineralization does not occur at all conditions. At CaCl₂) concentrations of 1 wt. % and 2 wt. % with EDTA concentrations of 3 wt. % and above, the pH of the fluids was at or above 8.0 and no precipitates were observed.

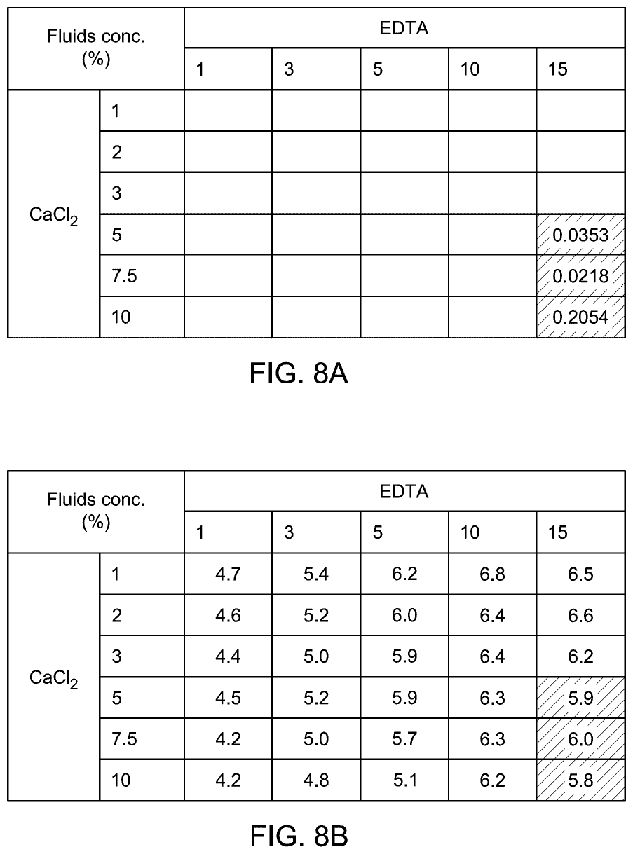

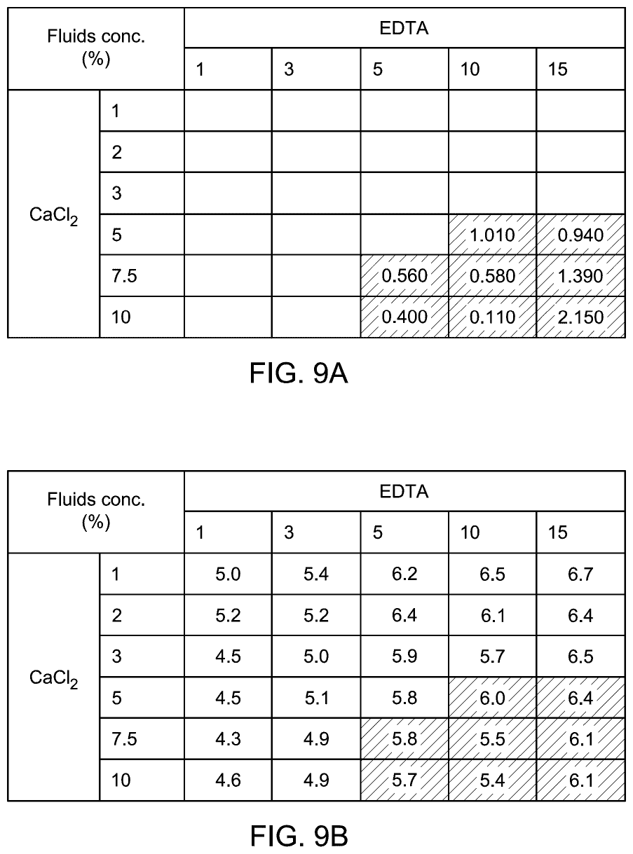

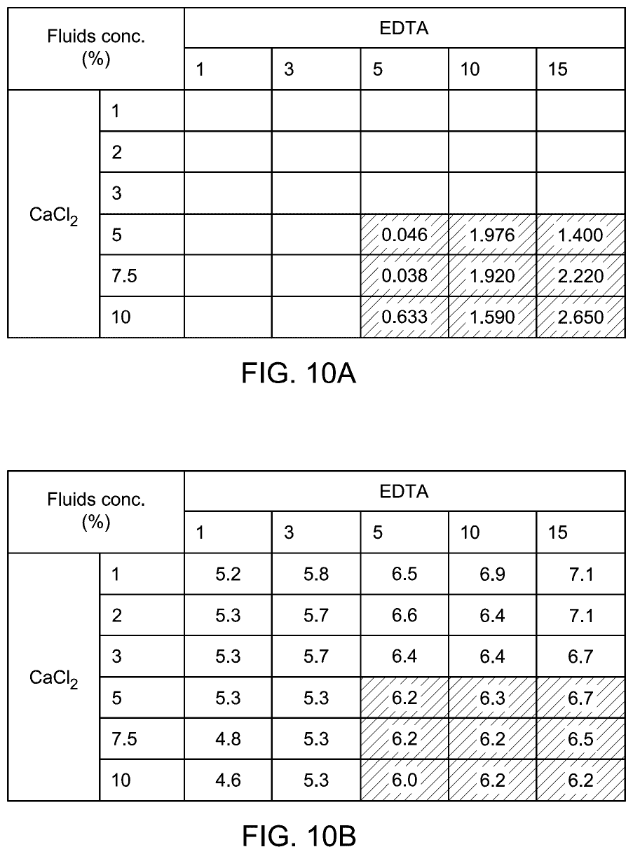

FIGS. 8A-8B and FIGS. 9A-9B depict subsurface mineralization of CO₂ at 30° C. and 50° C., respectively, and a pressure of 500 psi. In the instance of subsurface CO₂ mineralization where cation-rich solutions are exposed to high partial pressure of CO₂, the pH drops to values of about 3 to 4, which is a condition where mineralization may not be initiated. As shown in FIG. 8A, at a temperature of about 30° C., no mineralization was observed across the CaCl₂) and EDTA concentrations except at extreme conditions of a high EDTA concentration of about 15 wt. % and a minimum concentration of the CaCl₂) solution of about 5 wt. %. At 15 wt. % EDTA and a minimum of 5 wt. % CaCl₂), mineralization was achieved in the case of surface mineralization (see FIG. 6A). The higher pressure of CO₂ in subsurface mineralization (500 psi) results in increased CO₂ dissolution. Mineralization may not be achieved at 30° C. and 500 psi, except at a CaCl₂ concentration above 3 wt. % and a concentration of EDTA at about 15 wt. %; therefore, deep subsurface reservoirs with temperatures higher than 30° C. may be targeted to promote mineralization. 0.2054 g of precipitate was formed from a 50 mL 10 wt. % solution of CaCl₂ and a 15 wt. % solution of EDTA. Additional precipitates were seen under conditions that may not have been feasible at 30° C. A minimum CaCl₂) concentration of 5 wt. % and an EDTA concentration of 5 wt. % to 10 wt. % are needed at 50° C. for mineralization to occur. A maximum precipitate mass of 2.15 g was obtained at 50° C. with a CaCl₂) concentration of 10 wt. % and an EDTA concentration of 15 wt. % at a pressure of 500 psi (FIG. 9A). Similar CaCl₂ and EDTA concentration threshold observations with respect to a propensity of mineralization and an equilibrium pH were also made in instances at a temperature of 80° C. and a pressure of 500 psi, as shown in FIGS. 10A-10B. From the results depicted in FIGS. 8A-8B, FIGS. 9A-9B, and FIGS. 10A-10B, subsurface mineralization of CO₂ depends on temperature. The mass of precipitates, which relates to the amount of CO₂ stored in the subsurface, increases with an increase in reservoir temperature. Thus, for CO₂ mineralization, reservoirs with high temperatures are best suited for storage. An equilibrium pH is close to the average reservoir pH values of about 6 to 7 for the cases where the temperature was 50° C. and 80° C. An increase in the concentration of EDTA and CaCl₂ increases the mass of precipitates.

According to the present disclosure, a method of carbon dioxide mineralization is described. The method initiates an injection of CO₂ into a brine and, depending on the pH of the brine, it causes the CO₂ to dissolve and generate various specifications (CO₂, HCO₃⁻, and CO₃²⁻). The method disclosed herein further includes the dissolution of CaCl₂) and Na-EDTA, which may result in NaCl precipitation along with calcite. Parameters for the present disclosure include EDTA concentration, CaCl₂) concentration, temperature, pressure, and brine chemistry. For CO₂ mineralization, the brine includes at least 5 wt. % CaCl₂). This is to promote formation of stable calcites, which may provide storage security. High amounts of saline fluids may be produced by other processes, such as an effluent of water treatment processes. The method described in the present disclosure may provide production of carbonate and may further turn wastewater into resources for subsurface CO₂ storage.

The present disclosure includes precipitates with multiple morphologies such as rhombohedral and spherical. Forming multiple morphologies may be useful to determine stable morphologies formed during precipitation, which was calcite. Different morphologies relate to the stability and security of CO₂ storage as aragonite and vaterite are metastable and may transform into calcite with time. Thus, multiple morphologies may contribute to the security and long-term storage of captured CO₂. Formation of different morphologies indicate that several reaction paths exist which may be employed to improve kinetics of the mineralization process, promoting a faster route to CO₂ storage. Additionally, surface mineralization may find application in different morphologies produced due to their physical properties. Various morphologies have different surface area value and result in different porosities. Morphologies with high porosity and surface area may be employed to provide more sites for increased storage capacity.

SEM analysis depict that the calcite precipitates produced have distinct morphologies. Incorporation of Mg²⁺ into the spherical calcite precipitates inhibits spherical calcite from growing into rhombohedral or scalenohedral crystals. The magnesium content of the spherical calcite is insufficient to convert the calcite into dolomite. Magnesian calcite may be distinguished from a spherical calcite. Dolomite has 23 at. % magnesium, while spherical calcite has magnesium in an amount of 0.65 at. % to 1.88 at. %. The present disclosure depicts that the production of calcite minerals is possible and feasible in 24 hours. The method as described herein has applications for in situ precipitation for water shutdown and/or compliance control.

Mineralization of CO₂ produces calcite in less than a day (24 hours). This is predicated on the use of CaCl₂)-rich solutions with EDTA chelating agents and/or any other fluid having chelating agent-like properties. A CaCl₂)-rich solution and chelating agents (i.e., EDTA) can be used to precipitate calcium carbonate in less than 24 hours when reacted with CO₂; however, this depends on the chelating agent concentration, temperature, and pressure during operation. Five distinct crystal forms can be seen in the precipitated calcite: spherical, prismatic, rhombohedral, scalenohedral, and amorphous (infrequently). Precipitate mass increases with temperature, pressure, and EDTA and CaCl₂) concentration. Larger amounts of precipitates may occur at reservoir conditions. Various brines may be utilized to attain CO₂ mineralization as long as a minimum amount of CaCl₂) is met. The mineralization process may be fed by effluent from water treatment and/or reverse osmosis facilities. Numerous modifications and variations of the present disclosure are possible in light of the above teachings. Therefore, it is to be understood that within the scope of the appended claims, the disclosure may be practiced other than as specifically described herein.

1. A method of carbon dioxide mineralization, comprising:
injecting a brine solution into a subterranean geological formation,
wherein the brine solution comprises CaCl₂) in an amount of at least 2 wt. % based on a total weight of the brine solution and a chelating agent in an amount of at least 5 wt. % based on a total weight of the brine solution,
pressurizing the subterranean geological formation to a pressure of 20 to 2000 psi with carbon dioxide; and
reacting the carbon dioxide with the CaCl₂) in the subterranean geological formation at a temperature of 20 to 90° C. for 20 to 28 hours to form calcium carbonate in the subterranean geological formation,
wherein the calcium carbonate is in the form of crystals of aragonite, calcite, vaterite, and halite having spherical, prismatic, rhombohedral, and scalenohedral morphologies.

2. The method of claim 1, wherein the brine solution comprises one or more salts selected from a group consisting of NaCl, NaHCO₃, NaSO₄, MgCl₂, and CaCl₂).

3. The method of claim 1, wherein the chelating agent is an ethylenediaminetetraacetic acid.

4. The method of claim 1, wherein the brine solution has a total dissolved solids value of 55,000 to 60,000 ppm.

5. The method of claim 1, wherein the brine solution has a total dissolved solids value of 210,000 to 215,000 ppm.

6. The method of claim 5, wherein 4 to 5 times an amount of carbonate precipitate is formed at a temperature of 80° C. compared to the amount of carbonate precipitate formed at a temperature of 50° C. at a pressure of 50 psi and the chelating agent in an amount of 20 wt. %.

7. The method of claim 1, wherein the brine solution comprises CaCl₂ in an amount of 7.5 wt. %, and 55 to 60 times an amount of carbonate precipitate is formed at a chelating agent amount of 15 wt. % compared to the amount of carbonate precipitate formed at a chelating agent amount of 5 wt. % at a temperature of 80° C. at a pressure of 500 psi.

8. The method of claim 1, wherein the brine solution comprises CaCl₂) in an amount of 10 wt. %, and 18 to 24 times an amount of carbonate precipitate is formed at a chelating agent amount of 15 wt. % compared to the amount of carbonate precipitate formed at a chelating agent amount of 5 wt. % at a temperature of 30° C. at a pressure of 12 to 15 psi.

9. The method of claim 1, wherein the brine solution comprises CaCl₂) in an amount of 10 wt. %, and 5 to 10 times an amount of carbonate precipitate is formed at a chelating agent amount of 15 wt. % compared to the amount of carbonate precipitate formed at a chelating agent amount of 5 wt. % at a temperature of 50° C. at a pressure of 12 to 15 psi.

10. The method of claim 1, wherein the brine solution comprises CaCl₂) in an amount of 10 wt. %, and 3 to 7 times an amount of carbonate precipitate is formed at a chelating agent amount of 15 wt. % compared to the amount of carbonate precipitate formed at a chelating agent amount of 5 wt. % at a temperature of 50° C. at a pressure of 500 psi.

11. The method of claim 1, wherein the brine solution comprises CaCl₂ in an amount of 20 wt. % and the chelating agent in an amount of 10 wt. %, and 100 to 110 times an amount of carbonate precipitate is formed at a pressure of 1500 psi compared to the amount of carbonate precipitate formed at a pressure of 100 psi at a temperature of 50° C.

12. The method of claim 1, wherein reacting the carbon dioxide with the CaCl₂) forms one or more selected from a group consisting of calcite, vaterite, aragonite, and dolomite.

13. The method of claim 1, wherein reacting the carbon dioxide with the CaCl₂) forms at least one calcite having a morphology selected from the group consisting of spherical, prismatic, rhombohedral, scalenohedral, and amorphous.

14. The method of claim 13, wherein the morphology is rhombohedral having rectangular particles with a longest dimension of 25 to 150 μm and fractures in the rectangular particles having a length of 20 to 100 μm.

15. The method of claim 13, wherein the morphology is scalenohedral having particles with a longest dimension of 10 to 130 μm, wherein the particles comprise layered flakes having a longest dimension of 5 to 20 μm.

16. The method of claim 13, wherein the morphology is spherical having particles with a diameter of 2 to 15 μm.

17. The method of claim 13, wherein the morphology is prismatic having columnar particles with a longest dimension of 30 to 90 μm and a diameter of 5 to 12 μm.

18. The method of claim 1 wherein the brine solution comprises CaCl₂) in an amount of 20 wt. % and the chelating agent in an amount of 10 wt. %, and the carbonate precipitate formed comprises 3 to 5 wt. % aragonite, 80 to 85 wt. % calcite, 11 to 13 wt. % vaterite, and 0.5 to 1 wt. % halite at a pressure of 50 psi and a temperature of 80° C.

19. The method of claim 1, wherein the brine solution comprises CaCl₂) in an amount of 20 wt. % and the chelating agent in an amount of 10 wt. %, and the carbonate precipitate formed comprises 75 to 85 wt. % calcite and 15 to 25 wt. % vaterite at a pressure of 500 psi and a temperature of 80° C.

20. The method of claim 1, wherein the brine solution comprises CaCl₂ in an amount of 20 wt. % and the chelating agent in an amount of 10 wt. %, and the carbonate precipitate formed comprises 3 to 6 wt. % aragonite, 20 to 30 wt. % calcite, 1 to 5 wt. % vaterite, and 65 to 70 wt. % halite at a pressure of 1000 psi and a temperature of 80° C.
